(19) United States
(12) Patent Application Publication
(10) Pub. No.: US 2021/0011159 A1
(43) Pub. Date: Jan. 14, 2021

(54) Apparatus, System and Method for Infrastructure Monitoring

(71) Applicant: Arm Korea Limited, Seongnam-si (KR)

(72) Inventors: Woongsik Bill Woo, Seongnam-si (KR); Byungdoo Choi, Seongnam-si (KR); Dongmyoung Lee, Hwaseong-si (KR)

(73) Assignee: Arm Korea Limited, Seongnam-si (KR)

(21) Appl. No.: 16/565,224

(22) Filed: Sep. 9, 2019

(30) Foreign Application Priority Data
Jul. 10, 2019 (KR) 2019-83091

(51) Int. Cl. G01S 17/88; G01S 17/08; G01S 17/42

(52) U.S. Cl. CPC G01S 17/88; G01S 17/42; G01S 17/08

(57) ABSTRACT

A method of monitoring relative displacement between two structures using a distance measuring device is provided. The method includes transmitting, using at least one photo-emitter of the distance measuring device, a measurement signal; measuring, using a photo-sensor of the distance measuring device, a time-of-flight of the measurement signal, the time-of-flight being indicative of a distance between the distance measuring device and a component of a first structure, the distance measuring device being attached to a second structure, and the second structure being displaceable relative to the first structure; and transmitting, from a distance measuring device data transmitter to a remote resource using wireless communication, data relating to the displacement of the first structure relative to the second structure.

### BACKGROUND

The present techniques relate to the field of infrastructure monitoring. More particularly, the techniques relate to apparatus, systems and methods for monitoring displacement of structures, and more particularly monitoring the displacement of bridges.

Cloud computing services are becoming more common. More and more devices are being connected to the cloud. For example, relatively small devices such as temperature sensors, healthcare monitors and electronic door locks can be connected to the cloud so that they can be accessed and controlled using remote systems. Such devices may be called Internet of Things (IoT) devices. For example, a door may be remotely opened from a remote platform, or data from a temperature sensor or healthcare monitor may be aggregated at a remote location and accessed from another device. Hence, there is an increasing amount of data being collected by cloud platforms and their providers.

In some examples of infrastructure monitoring, the measurement of the displacement of structures, such as bridges, can be performed by the use of the global positioning system (GPS) to provide position data for structure components. However the accuracy of such measurements, especially in urban environments is limited. Such measurements can be improved by the use of pseudo-satellites, or pseudolites, to augment or replace the GPS position data, thereby improving accuracy, availability, reliability and integrity of the positional measurements of the structure, especially in urban environments, though this increases cost and complexity of the measurement system.

In other examples, the measurement of the displacement of structures, such as bridges, can be performed by the use of marking devices positioned between sections of the structure, for example between a pillar and a road section of a bridge or between two road sections of the bridge, whereby the displacement of one bridge section relative to another bridge section causes the marking device to trace the relative displacement of the bridge sections over time. Such traces can then be monitored as part of regular maintenance of the bridge by maintenance staff. However, such examples require maintenance staff to replace the marking devices on a regular basis, where access to the marking devices may be limited or pose significant hazards.

It would therefore be desirable to provide an alternative system.

### BRIEF DESCRIPTION OF THE DRAWINGS

Embodiments will now be described with reference to the accompanying figures of which:

FIG. 1 illustrates a schematic diagram of an apparatus according to various examples;

FIG. 2 illustrates a schematic diagram of a system according to various examples;

FIG. 3 illustrates an example apparatus in-situ for monitoring relative displacement between two structures;

FIG. 4 is an enlarged section A of FIG. 3 illustrating an example apparatus in-situ for monitoring relative displacement between two structures;

FIG. 5 illustrates a flow diagram of blocks of a method according to various examples;

FIG. 6 illustrates a flow diagram of blocks of a method according to various examples;

FIG. 7 illustrates a flow diagram of blocks of a method according to various examples;

FIG. 8 illustrates a flow diagram of blocks of a method according to various examples; and

FIG. 9 illustrates a flow diagram of blocks of a method according to various examples.

### DETAILED DESCRIPTION

According to an aspect of the present technique, there is provided a method of monitoring relative displacement between two structures using a distance measuring device, the method comprising: transmitting, using at least one photo-emitter of the distance measuring device, a measurement signal; and measuring, using a photo-sensor of the distance measuring device, a time-of-flight of the measurement signal, the time-of-flight being indicative of a distance between the distance measuring device and a component of a first structure, the distance measuring device being attached to a second structure, the second structure being displaceable relative to the first structure; and transmitting, from a distance measuring device data transmitter to a remote resource using wireless communication, data relating to the displacement of the first structure relative to the second structure.

According to an aspect of the present technique, there is provided a distance measuring device, for monitoring relative displacement between two structures, comprising: a photo-emitter to transmit a measurement signal; a photo-sensor to measure a time-of-flight of the measurement signal, the time-of-flight being indicative of a distance between the distance measuring device and a component of a first structure, the distance measuring device being attached, in use, to a second structure, the second structure being displaceable relative to the first structure; and a distance measuring device data transmitter to transmit, to a remote resource using wireless communication, data relating to the displacement of the first structure relative to the second structure.

According to an aspect of the present technique, there is provided system for monitoring relative displacement between two structures, the system comprising: a distance measuring device, for monitoring relative displacement between two structures, comprising: a photo-emitter to transmit a measurement signal; a photo-sensor to measure a time-of-flight of the measurement signal, the time-of-flight being indicative of a distance between the distance measuring device and a component of a first structure, the distance measuring device being attached, in use, to a second structure, the second structure being displaceable relative to the first structure; and a distance measuring device data transmitter to transmit, to a remote resource using wireless communication, data relating to the displacement of the first structure relative to the second structure; and a remote resource to receive data, from the distance measuring device data transmitter, relating to the displacement of a first structure relative to a second structure.

As will be appreciated by one skilled in the art, the present techniques may be embodied as an apparatus, a system, or a method. In some embodiments some or all of the method may be carried out using a computer program. Accordingly, present techniques may take the form of an entirely hardware embodiment, an entirely software embodiment, or an embodiment combining software and hardware aspects.

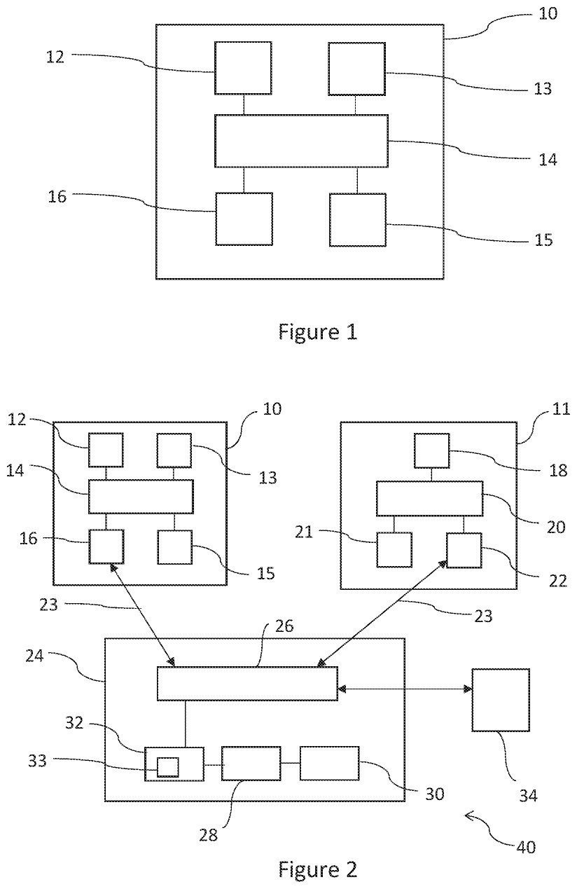

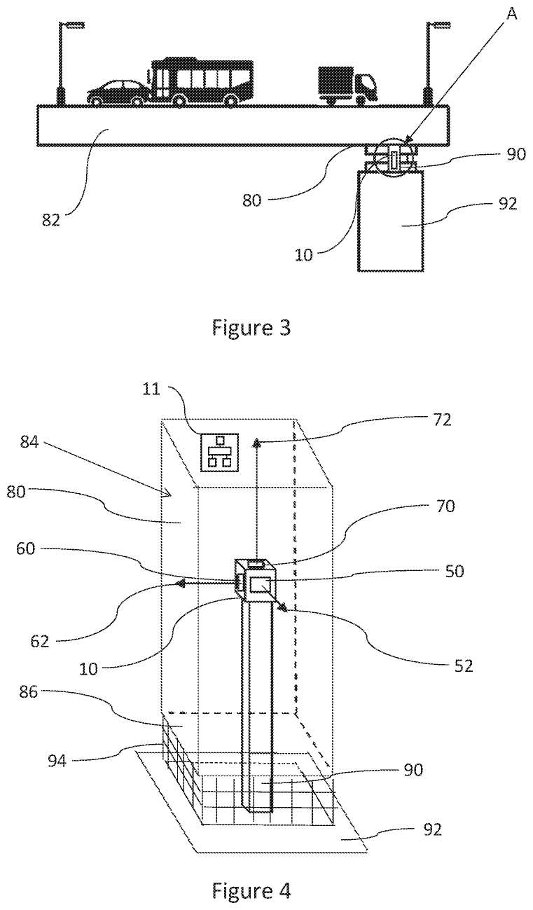

FIG. 1 illustrates a schematic diagram of an apparatus 10 in the form of a distance measuring device 10 comprising: a sensor arrangement in the form of a photo-emitter 12 to transmit a measurement signal; a photo-receiver, or photo-sensor 13, to measure a time-of-flight of the measurement signal, the time-of-flight being indicative of a distance between the distance measuring device 10 and a component of a first structure 80, as illustrated in FIGS. 3 and 4, the distance measurement device 10 being attached, in use, to a second structure 90, as illustrated in FIGS. 3 and 4, separate to the first structure 80, the second structure 90 being displaceable relative to the first structure 80; and a distance measuring device data transmitter 16, which may be in the form of communication circuitry, to transmit, to a remote resource 24 using wireless communication 23, as illustrated in FIG. 2, data relating to the displacement of the first structure 80 relative to the second structure 90.

The distance measuring device 10 may comprise a distance measuring device processor 14, which may be in the form of processing circuitry, to generate distance data indicative of the distance between the distance measuring device 10 and the component of the first structure 80.

The distance measurement device 10 may be a device connected or connectable to a cloud service or a computing grid.

By the distance measurement device 10 being attached, in use, to the second structure 90, it is considered that the distance measurement device 10 is in a fixed physical or structural association with the second structure 90, such that the position of the distance measurement device 10 is fixed relative to the second structure 90. By fixing the position of the distance measurement device 10 relative to the second structure 90, any measurement of the distance between the distance measurement device 10 and a component of a first structure 80 provides information regarding the position of the first structure 80 relative to the second structure 90.

The physical association between the distance measurement device 10 and the second structure 90 may be by direct, or indirect physical attachment, for example by adhering, bolting or otherwise physically connecting the distance measurement device 10 to the second structure 90, or by adhering, bolting or otherwise physically connecting the distance measurement device 10 to a mounting structure which is physically connected to the second structure 90.

The photo-emitter 12 and photo-sensor 13 pair provides a non-contact based sensing means. The sensing means may be capable of accurate measurements up to 20 cm, for example between +/−10 cm from a central point, and be capable of measuring distances within a desired accuracy for monitoring relative displacement between two structures.

Alternatively, alternative non-contact proximity type sensors in the form of an inductive, capacitive, photoelectric or ultrasonic sensor may be used. For example an ultrasonic emitter and receiver pair can be used in place of the photo-emitter 12 and photo-sensor 13 pair.

Alternatively, contact based sensors similar to a profilometer may be used. Some contact based sensors may use the physical modification of an elastic spring to indicate or infer a relative displacement between two structures to which the elastic spring is connected. Various parameters of such a connected electric spring may be determined to infer the magnitude of the displacement between the two structures.

Other contact based sensors can be used, such as a linear potentiometer, or slide potentiometer connected to the first structure 80 and the second structure 90. Displacement of the first structure 80 relative to the second structure 90 causes a linear translation of a sliding contact on a resistance track of the potentiometer, resulting in a change in a measured resistance at the potentiometer, which is related to the distance that the first structure 80 is displaced from the second structure 90. The relationship between measured resistance at the potentiometer and the distance that the first structure 80 is displaced from the second structure 90 may be linear. Multiple linear potentiometers, or slide potentiometers, can be used to measure the relative displacement between the first structure 80 and the second structure 90 in different axes.

The distance measurement device 10 may be a low power device, capable of uninterrupted operation for a number of months, for example two, three or four months, and be rugged to operate outdoors in harsh conditions.

A specific, non-limiting example system 40, incorporating the distance measurement device 10, will now be described in relation to FIGS. 2, 3 and 4.

In the embodiment shown in FIG. 3, the distance measurement device 10 is installed between the first structure 80 and the second structure 90 to monitor displacement therebetween. The first structure 80 is, forms part of, or is connected to, a roadway, railway or footpath 82. The second structure 90 is, forms part of, or is connected to, a supporting pillar 92 for the roadway, railway or footpath 82. Thus the distance measurement device 10 can be seen to be monitoring displacement of a roadway 82 with respect to a supporting pillar 92.

In the embodiment shown in FIG. 4, which is a magnified section A of FIG. 3, the distance measurement device 10 comprises three photo-emitter 12 and photo-sensor 13 pairs, a first pair 50 being aligned on a first axis 52, a second pair 60 being aligned on a second axis 62, and a third pair 70 being aligned on a third axis 72. Each of the photo-emitters 12 may comprise a light emitting diode or laser based transmitter and each of the photo-sensors 13 may comprise a photodiode or phototransistor receiver.

The distance measurement device 10 is connected to the second structure 90 either directly or via a support, such as a bracket.

The first structure 80 may be a first bridge section. The first structure 80 may be a surface of the first bridge section. In FIG. 3 the first structure 80 is illustrated as a lower part of a roadway, railway or footpath 82 of the bridge, the roadway, railway or footpath 82 of the bridge being supported by a pillar 92 of the bridge.

In FIG. 4, the first structure 80 is illustrated as a box section 84 comprised in or as part of, or attached to, the lower portion of the first bridge section, the box section 84 having internal surfaces on four sides and an upper surface.

The lower end 86 of the box section 84 is open and at least part of the second structure 90, is located within the box section 84 such that the distance measurement device 10, attached to the second structure 90, is located within the box section 84.

The second structure 90 may be a second bridge section. The second structure 90 may be a surface of the second bridge section. In FIG. 3 the second structure 90 is illustrated as part of a pillar or stanchion 92 of the bridge for supporting the roadway, railway or footpath 82 of the bridge. In an alternative arrangement, the second structure 90 may be a freestanding pillar not forming part of the bridge.

In FIG. 4, the second structure 90 is illustrated attached to or forming an upper part of the pillar 92 with a distance measurement device 10 attached thereto. The distance measurement device 10 is located within the box section 84 of the first structure 80.

A barrier 94 may be positioned at the lower end 86 of the box section 84 and connected or attached thereto, and be connected or attached to the second structure 90. The distance measuring device 10 may be positioned, in use, within the barrier, between the component of the first structure 80 and the second structure 90. The barrier 94 may restrict or prevent the ingress of dirt, insects, animals and the like into the box section 84 and fouling the distance measurement device 10 or interfering with measurements by the distance measurement device 10. The barrier 94 may be a seal to provide a sealed environment or substantially sealed environment. Alternatively, the barrier 94 may be a mesh, spikes, wires, grid, or other device, for the restriction or prevention of ingress of animals and/or insects and the like into the box section 84. The barrier 94 may be flexible such that relative displacement or movement between the first structure 80 and the second structure 90 does not affect the ability of the barrier 94 to prevent the ingress of dirt, insects, animals and the like into the box section 84. A rubber tubular sheath or a concertinaed plastic tubular sheath may be provided which are sealed to the box section 84 and further sealed to the second structure 90 via cable ties or similar.

The distance measuring device 10 is configured to measure the distance between the distance measuring device 10 and the component of the first structure 80 in three axes 52, 62, 72, each of the three axis 52, 62, 72 being perpendicular to the other two axes.

The distance measuring device 10 comprises three sensing elements 50, 60, 70, each comprising a photo-emitter 12 and photo-sensor 13 pair, configured to sense or measure along one of the three axes 52, 62, 72. A first sensing element 50 is configured to measure the distance between the distance measuring device 10 and the component of the first structure 80 in a first axis 52. A second sensing element 60 is configured to measure the distance between the distance measuring device 10 and the component of the first structure 80 in a second axis 62. A third sensing element 70 is configured to measure the distance between the distance measuring device 10 and the component of the first structure 80 in a third axis 72.

Electromagnetic radiation, which may for example be visible light or infra-red radiation, is transmitted from a photo-emitter 12, for example a light emitting diode or laser, at each sensing element 50, 60, 70, towards a surface of the component of the first structure 80, travelling along, or substantially along, the respective axis 52, 62, 72. The electromagnetic radiation is reflected at the component of the first structure 80 and returns back to a photo-sensor 13, for example a photodiode, at the respective sensing element 50, 60, 70. The transmitted light may be in the form of a short optical pulse. The time taken for the light to travel from the photo-emitter 12 and be reflected back to the photo-sensor 13 provides a measure of the distance between the sensing element 50, 60, 70 of the distance measuring device 10 and the component of the first structure 80. It will be understood that various known methods of measuring distance using time-of-flight measurements can be used without departing from the scope of the present disclosure. For example, a short pulse of light can be sent as described above, or a phase shift method may be used, utilising continuously modulated electromagnetic radiation.

Once the electromagnetic radiation is received back from the component of the first structure 80, a distance measuring device processor 14 generates distance data indicative of the distance between the distance measuring device 10 and the component of the first structure 80. In a simple pulsed time of flight arrangement as described above, the distance measuring device processor 14 utilises the time taken for the electromagnetic pulse to travel from the photo-emitter 12 to the photo-sensor 13, divides this value by two to account for the return travel and divides the resulting value by the speed of light to generate distance data indicative of the distance between the distance measuring device 10 and the component of the first structure 80. This simplistic measurement requires, at least, the photo-emitter 12 and the photo-sensor 13 to be the same distance from the component of the first structure 80, thus requiring the photo-emitter 12 and photo-sensor 13 to be located in the same plane. If the photo-emitter 12 and photo-sensor 13 are located different distances away from the component of the first structure 80, in other words in different planes, then the distance measuring device 10 is required to be calibrated to account for the offset between the photo-emitter 12 and photo-sensor 13.

A distance measuring device data transmitter 16 is used to transmit, to a remote resource 24, data relating to the displacement of the first structure 80 relative to the second structure 90.

The data relating to the displacement of the first structure 80 relative to the second structure 90 may either be the distance data generated by the distance measuring device processor 14, or may be a calculated value of the displacement of the first structure 80 relative to the second structure 90.

The distance data generated by the distance measuring device processor 14 may be transmitted to the remote resource 24 via the distance measuring device data transmitter 16, where it is processed by the remote resource 24 to determine the displacement of the first structure 80 relative to the second structure 90.

Alternatively, the distance data generated by the distance measuring device processor 14 is processed by the distance measuring device processor 14 to determine the displacement of the first structure 80 relative to the second structure 90 and then transmitted to the remote resource 24 via the distance measuring device data transmitter 16. The distance data can be analysed for historical trends and historical data can be used for predicting future events.

The distance measuring device data transmitter 16, which may be in the form of communication circuitry, may be part of a transmitter-receiver or transceiver arrangement or circuitry.

The distance measuring device data transmitter 16 and/or receiver may use wireless communication 23, such as communications used for communicating with remote devices, such as internet of things (IoT) devices, such as those communications used in, for example, wireless local area networks (WLAN) and/or wireless sensor networks (WSN) such as Wi-Fi, ZigBee, Bluetooth or Bluetooth Low Energy (BLE), using any suitable communications protocol such as lightweight machine-to-machine (LWM2M). The distance measuring device data transmitter 16 and/or receiver may use cellular communication.

The distance measuring device 10 may comprise a distance measuring device memory 15, which may be in the form of storage circuitry (e.g. non-volatile/volatile storage) to store the distance data generated by the distance measuring device processor 14 and/or data relating to the determined values of the displacement of the first structure 80 relative to the second structure 90, prior to being transmitted to the remote resource 24 via the distance measuring device data transmitter 16. The distance measuring device memory 15 may store the distance data generated by the distance measuring device processor 14 and/or the data relating to the determined values of the displacement of the first structure 80 relative to the second structure 90, for a period of time such that continuous connection to the remote resource 24 is not necessary, thus alleviating any temporary loss of connectivity between the distance measuring device 10 and the remote resource 24, or allowing intermittent data transfer between the distance measuring device 10 and the remote resource 24. For example, data may be transmitted or polled from the distance measuring device 10 on an hourly basis, requiring data over the preceding hour to be stored in distance measuring device memory 15.

The distance data may be stored in distance measuring device memory 15 and may be processed to reduce data requirements, for example by averaging data or storing only minimum and maximum values or storing only the most recent data such that distance measuring device memory 15 requirements may be reduced.

The distance measuring device 10 may also store device data in distance measuring device memory 15. Such device data includes identifier data comprising one or more device identifiers to identify the distance measuring device 10 and may comprise one or more of: universally unique identifier(s) (UUID), globally unique identifier(s) (GUID) and IPv6 address(es), although any suitable device identifier(s) may be used.

The device data may also include authentication data for establishing trust/cryptographic communications between the distance measuring device 10 and the remote resource 24. Such authentication data may include certificates (e.g. signed by a root authority), cryptographic keys (e.g. public/private key pairs; symmetric key pairs), tokens etc. The authentication data may be provisioned on the distance measuring device 10 by any authorised party (e.g. by an owner, a manufacturer or an installer).

The distance measuring device 10 can be configured, by a user, to take measurements periodically. The period between measurements may be set by the user in order to achieve required data granularity and/or reduce the processing burden and/or energy consumption of the distance measuring device 10.

As shown in FIG. 2 and FIG. 4, the system 40 may also comprise a temperature measurement device 11. The temperature measurement device 11 may comprise one or more temperature sensor 18 to measure a temperature at or of one or both of the first structure 80 and the second structure 90.

For example, the temperature measurement device 11 may comprise a first temperature sensor 18 to measure a temperature at or of one of the first structure 80 and the second structure 90. The temperature measurement device 11 may comprise a second temperature sensor 18 to measure a temperature at or of the other one of the first structure 80 and the second structure 90. More than one temperature sensor 18 may be used to determine the temperature at or of one or both of the first structure 80 and the second structure 90. This may improve accuracy of temperature measurement and/or account for errors or failures in one or more temperature sensor 18. Alternatively, the first temperature sensor 18 may measure a temperature at or of both of the first structure 80 and the second structure 90.

The temperature measurement device 11 may comprise a temperature measurement device processor 20 to generate temperature data indicative of the temperature at or of one or both of the first structure 80 and the second structure 90. The temperature measurement device processor 20 may process the measured temperature to determine a change in temperature for a specified time period. The specified time period may be set by a user to provide required data granularity. The specified time period may coincide with the time between distance measurements taken using the distance measuring device 12.

The temperature measurement device 11 may comprise a temperature measurement device data transmitter 22, configured to transmit, to the remote resource, data relating to the temperature at or of one or both of the first structure 80 and the second structure 90. The temperature measurement device data transmitter 22, which may be in the form of communication circuitry, may be part of a transmitter-receiver or a transceiver arrangement.

The temperature measurement device data transmitter 22 and/or receiver may use wireless communication 23, such as communications used for communicating with remote devices, such as internet of things (IoT) devices, such as those communications used in, for example, wireless local area networks (WLAN) and/or wireless sensor networks (WSN) such as Wi-Fi, ZigBee, Bluetooth or Bluetooth Low Energy (BLE), using any suitable communications protocol such as lightweight machine-to-machine (LWM2M). The temperature measurement device data transmitter 22 and/or receiver may use cellular communication.

The temperature measurement device 11 may comprise a temperature measurement device memory 21 which may be in the form of storage circuitry (e.g. non-volatile/volatile storage). The temperature measurement device processor 20 may be connected to the temperature measurement device memory 21. The temperature measurement device memory 21 may store the temperature data generated by the temperature measurement device processor 20 and/or the determined change of temperature values for one or both of the first structure 80 and the second structure 90, for a period of time such that continuous connection to the remote resource 24 is not necessary, thus alleviating any temporary loss of connectivity between the temperature measurement device 11 and the remote resource 24, or allowing intermittent data transfer between the temperature measurement device 11 and the remote resource 24.

The temperature measurement device 11 may also store device data in temperature measurement device memory 21. Such device data includes identifier data comprising one or more device identifiers to identify the temperature measurement device 11 and may comprise one or more of: universally unique identifier(s) (UUID), globally unique identifier(s) (GUID) and IPv6 address(es), although any suitable device identifier(s) may be used.

The device data may also include authentication data for establishing trust/cryptographic communications between the temperature measurement device 11 and the remote resource 24. Such authentication data may include certificates (e.g. signed by a root authority), cryptographic keys (e.g. public/private key pairs; symmetric key pairs), tokens etc. The authentication data may be provisioned on the temperature measurement device 11 by any authorised party (e.g. by an owner, a manufacturer or an installer).

As shown in FIG. 2, the remote resource 24 may comprise a transmitter-receiver arrangement or a transceiver 26 to wirelessly receive data from the distance measuring device 10 and/or the temperature measurement device 11. In particular the remote resource 24 may receive data, from the distance measuring device data transmitter 16, relating to the displacement of a first structure 80 relative to a second structure 90 and/or data, from the temperature measurement device data transmitter 22, relating to the temperature at or of the one or both of the first structure 80 and the second structure 90.

The remote resource may comprise a monitoring service 28. In alternative arrangements the monitoring service 28 may be separate to the remote resource 24 and be connected thereto with a wired or wireless arrangement. The monitoring service 28 monitors the data received from the distance measuring device data transmitter 16 and/or from the temperature measurement device data transmitter 22. When data is received from both the distance measuring device data transmitter 16 and the temperature measurement device data transmitter 22, the monitoring service 28 can correlate displacement data for the first structure 80 relative to the second structure 90 with the temperature data. Therefore, the monitoring service 28, or a user of the monitoring service 28, can determine if there are any anomalies in the data that may indicate that intervention is required, for example by maintenance crew or a technician to service or maintain the first structure 80 and/or second structure 90. By correlating with temperature data, the expected displacement of the first structure 80 relative to the second structure 90 for a given temperature can be taken into consideration in any analysis of the displacement data to ensure that expected displacements do not give rise to any indication of an anomaly.

As shown in FIG. 2, the remote resource 24 may also comprise a notification service 30. In alternative arrangements the notification service 30 may be separate to the remote resource 24 and be connected thereto with a wired or wireless arrangement. In some arrangements the notification service 30 forms part of the monitoring service 28. The notification service 30 is configured to provide notification to a user that one or more measured parameter has exceeded a predetermined threshold.

For example, it is known that structures expand and contract as the temperature of those structures increases or decreases. With a structure comprising a first structure 80 and a second structure 90 which are collocated it may be expected that there is an acceptable displacement of the first structure 80 relative to the second structure 90 for a given temperature change. The monitoring service 28 is used to monitor the displacement of the first structure 80 relative to the second structure 90 and also to monitor the temperature change. The monitoring service 28 monitors the displacement of the first structure 80 relative to the second structure 90 with respect to acceptable displacement limits or thresholds for the given temperature change. If the acceptable displacement limit or threshold is exceeded when the given temperature change is observed, then the notification service 30 can alert the user to the anomaly. The acceptable displacement of the first structure 80 relative to the second structure 90 for a given temperature can be provided as a threshold value, which may be stored at one or more of the remote resource 24, the monitoring service 28, and the notification service 30. Alternatively, multiple thresholds can be provided giving different levels of warning depending on the severity of the displacement between the first structure 80 and the second structure 90. Such severity levels could be indicated by various visual and/or audible warnings. The warnings could be, for example, displayed on a mobile device, which is carried by a user when the user is on duty for monitoring the structures, or could be at a control centre. The warnings may be pushed to the mobile device to alert the user to the anomaly.

The remote resource 24 may comprise a mobile device, computer terminal, service (e.g. cloud service), gateway device etc.

FIG. 2 schematically illustrates a system 40 having one distance measuring device 10 and one temperature measurement device 11. It will be understood that such a system 40 may comprise multiple distance measuring devices 10 and/or multiple temperature devices 11.

The distance measuring device 10 and temperature measurement device 11 may communicate with each other, for example using a wireless mesh network.

The distance measuring device 10 and temperature measurement device 11 communicate with remote resource 24 in the system 40, whereby remote resource 24 may comprise one or more services, which may be cloud services, applications, platforms, computing infrastructure etc.

The remote resource 24 may be located on a different network to the distance measuring device 10 and temperature measurement device 11 (e.g. on the internet), whereby the distance measuring device 10 and temperature measurement device 11 connect thereto via a gateway device (not shown). However, one or more of the services may be located in the same network as the distance measuring device 10 and temperature measurement device 11 (e.g. running on a server in the same WLAN).

In the present illustrative example, the remote resource 24 comprises management service 32, monitoring service 28 and notification service 30, but this list is not exhaustive and the remote resource 24 may comprise other services.

Management service 32 is used to provision the respective distance measuring device 10 and temperature measurement device 11 with device data such as firmware data, authentication data, registration data and/or update data (e.g. updates to firmware or authentication data). Such a management service 32 may comprise the mBED platform provided by ARM® of Cambridge (UK). In other examples, the management service may comprise a device (e.g. a server).

The monitoring service 28 performs analytics on the device data (e.g. sensed data) received thereat to generate analytics results based on or in response thereto, whereby, in the present illustrative examples, the distance measuring device 10 and temperature measurement device 11 transmit device data to the monitoring service 28 via the management service 32.

A third party, for example, that may be interested in the analytics results (hereafter “interested party”) can then access the analytics results whereby, for example, the monitoring service 28 communicates the analytics results directly to an application device 34 or to an account of the interested party. In a further example, the interested party may access the analytics results using an application device 34 (e.g. via a user interface (UI) on the application device).

Such analytics results may include a pivot table(s) or a graphical representation of the device data. The monitoring service 28 may also process the device data received from the distance measuring device 10 and temperature measurement device 11 to perform deep learning analysis thereon, and may also comprise a logic engine to take an action in response to processing the device data. Such an action may comprise sending a command communication comprising an instruction(s) or request(s) to distance measuring device 10 and/or temperature measurement device 11. Historical data can be processed and made available to users via the application devices 34.

It will be appreciated that in the context of the present description, an interested party may be one or more humans (e.g. maintenance staff, infrastructure owner etc.) or an interested party may one or more applications or programs (e.g. artificial intelligence (AI)).

The application devices 34 may communicate with one or more of the distance measuring device 10 and temperature measurement device 11 via remote resource 24, whereby an interested party may transmit a command communication from the application devices 34 to one or more of the distance measuring device 10 and temperature measurement device 11 (e.g. using a UI).

As an illustrative example, an interested party can, on interpreting the analytics results, send a command communication instructing distance measuring device 10 and temperature measurement device 11 to generate data output on a more frequent basis.

In a further illustrative example, the distance measuring device 10 and/or temperature measurement device 11 can transmit device data to the application device 34 such that an interested party could, via a UI thereon, monitor or check the status of the distance measuring device 10 and/or temperature measurement device 11.

The system 40 may also comprise a bootstrap service 33 to provision device data onto the distance measuring device 10 and/or temperature measurement device 11. In the present illustrative example, bootstrap service 33 is provided as part of the management service 32, but it may be a separate service (e.g. a cloud service).

Each distance measuring device 10 and/or temperature measurement device 11 may be provisioned with bootstrap data at manufacture, such as an identifier or an address for the bootstrap service 33, to enable the distance measuring device 10 and/or temperature measurement device 11 to communicate with the bootstrap service 33 when first powered on, so as to receive the appropriate device data therefrom.

The bootstrap data may also comprise authentication data to enable the distance measuring device 10 and/or temperature measurement device 11 to authenticate itself with the bootstrap service 33. The authentication data may comprise a cryptographic key (e.g. a private key) or a certificate, which may be from a trusted authority. Such functionality provides that only distance measuring device 10 and/or temperature measurement device 11 having such authentication data will be able to connect with the bootstrap service 33, and may reduce the likelihood of rogue devices connecting therewith.

The device data received from the bootstrap service 33 may comprise firmware and may also comprise an identifier or an address for one or more resources/services with which the distance measuring device 10 and/or temperature measurement device 11 should communicate with.

In examples, the device data received from the bootstrap service 33 may be signed (e.g. using a private key of the bootstrap service 33) such that the distance measuring device 10 and/or temperature measurement device 11 can verify the device data as being from a trusted source using corresponding authentication data provisioned thereon (e.g. a public key or certificate of the bootstrap service 33). If a distance measuring device 10 and/or temperature measurement device 11 cannot verify a signature on received communications, it may disregard such communications. Therefore, the distance measuring device 10 and/or temperature measurement device 11 may only accept, process and/or install data that has been verified as being from a trusted source. The cryptographic keys for communicating with bootstrap service 33 may be provisioned on the respective distance measuring device 10 and/or temperature measurement device 11 at manufacture, for example. It will also be appreciated that the distance measuring device 10 and/or temperature measurement device 11 can encrypt communications transmitted to the bootstrap service 33 using the public key of the bootstrap service 33.

As described with respect to the bootstrap service 33 above, the distance measuring device 10 and/or temperature measurement device 11 may also be provisioned with authentication data for other remote resources (e.g. the management service 32, monitoring service 28, notification service 30, application device(s) 34, distance measuring device 10 and/or temperature measurement device 11).

The authentication data may comprise a public key or certificate for the respective remote resources, and may be provisioned thereon, for example, by the bootstrap service 33 as part of the bootstrap process, or as part of a registration process with the management service 32 or monitoring service 28.

Such functionality provides for different levels of access to the respective distance measuring device 10 and/or temperature measurement device 11 by different resources.

In an illustrative example, command communications signed using a first cryptographic key may authorise the resource signing the command communication to modify the measurement frequency of the distance measuring device 10 and/or temperature measurement device 11, whilst command communications signed using a second cryptographic key may authorise the signing resource to request sensed data from the distance measuring device 10 and/or temperature measurement device 11, but not to adjust the measurement frequency. A third key associated with the management service may provide unrestricted control of the distance measuring device 10 and/or temperature measurement device 11.

Therefore, on receiving communications from a remote resource 24, the distance measuring device 10 and/or temperature measurement device 11 can, in a first instance, verify whether the remote resource 24 is authorised to communicate therewith, and, in a second instance, verify that the remote resource 24 is authorised to request the instructions in the communications to be performed.

The system 40 may also comprise a registry resource to manage the identifier data on the distance measuring device 10 and/or temperature measurement device 11, whereby managing the identifier data may include generating, maintaining and/or disbanding the identifier data as appropriate. The registry resource can generate the identifier data and transmit it to another remote resource (e.g. a manufacturer) for provisioning on the distance measuring device 10 and/or temperature measurement device 11. Such a registry resource may be provided as part of the management service 32.

The communications between the distance measuring device 10 and/or temperature measurement device 11, the remote resource 24 and/or the application devices 34 may optionally be provided with end-to-end security, such as transport layer security (TLS), datagram transport layer security (DTLS) or secure socket layer (SSL). As above, the authentication data (certificates/keys) required for end-to-end security may be provisioned on the distance measuring device 10 and/or temperature measurement device 11, monitoring service 28 and application devices 34 by, for example, the management service 32.

Such end-to-end security reduces the likelihood that the device data or the analytics results will be accessed by an unauthorised party.

The distance measuring device 10 and/or temperature measurement device 11 may automatically determine their respective location or positions in a particular area by communicating with each other using a location determination protocol such as a MESH protocol, provisioned thereon during the bootstrap process.

As an illustrative example, when a distance measuring device 10 and/or temperature measurement device 11 is replaced, the replacement distance measuring device 10 and/or temperature measurement device 11 is powered on and it executes its bootstrapping process and is provisioned with device data comprising a location determination protocol, such that it resolves its location by communicating with other distance measuring devices 10 and/or temperature measurement devices 11. The replacement distance measuring device 10 and/or temperature measurement device 11 can then communicate its location to the management service 32 which can provision the appropriate device data for its location thereon.

Similarly, when an existing distance measuring device 10 and/or temperature measurement device 11 is moved to a new location, it may determine its new location by communicating with distance measuring device 10 and/or temperature measurement devices 11 at the new location, and communicate its updated location to management service 32 so as to be provisioned with the appropriate device data for its new location.

Furthermore, when device data (e.g. firmware, authentication data) for a particular distance measuring device 10 and/or temperature measurement device 11 is updated, the management service 32 can communicate with the distance measuring device 10 and/or temperature measurement device 11 so as to provision the distance measuring device 10 and/or temperature measurement device 11 with the updated device data.

Furthermore, a distance measuring device 10 and/or temperature measurement device 11 can verify that other distance measuring devices 10 and/or temperature measurement devices 11 are operating as expected, whereby the distance measuring device 10 and/or temperature measurement device 11 may transmit a status communication periodically (e.g. second(s), minute(s), hour(s) etc.). In the present illustrative example the status communication comprises a ping, although it may take any suitable format.

A distance measuring device 10 and/or temperature measurement device 11 receiving the ping within a threshold timeframe can determine that the distance measuring device 10 and/or temperature measurement device 11 transmitting the ping is operating as expected.

When a distance measuring device 10 and/or temperature measurement device 11 does not receive an expected ping within the threshold time it can take appropriate action, such as sending a communication to the remote resource 24 warning that no ping was received. The remote resource 24 may then send a notification to an interested party (e.g. maintenance staff) to resolve any potential issue with the malfunctioning distance measuring device 10 and/or temperature measurement device 11.

Whilst the temperature measurement device 11 is illustrated separately to the distance measurement device 10 in FIG. 2 and FIG. 4, it will be understood that in some embodiments the temperature measurement device 11 can be formed as part of the distance measurement device 10 and/or be collocated to share common circuitry, such as one or more of memory, processor and communication circuitry. In such embodiments where the distance measurement device 10 and the temperature measurement device 11 are comprised in a single device, there may be a single transmitter, which may be in the form of communication circuitry, and which may be part of a transmitter-receiver or a transceiver arrangement. The single transmitter may then transmit, to a remote resource 24 using wireless communication 23, data relating to the displacement of the first structure 80 relative to the second structure 90 and/or data relating to the temperature at or of the one or both of the first structure 80 and the second structure 90. The period between transmissions of the data relating to the displacement of the first structure 80 relative to the second structure 90 and the data relating to the temperature at or of the one or both of the first structure 80 and the second structure 90 may be the same or may be different to account for faster varying data parameters.

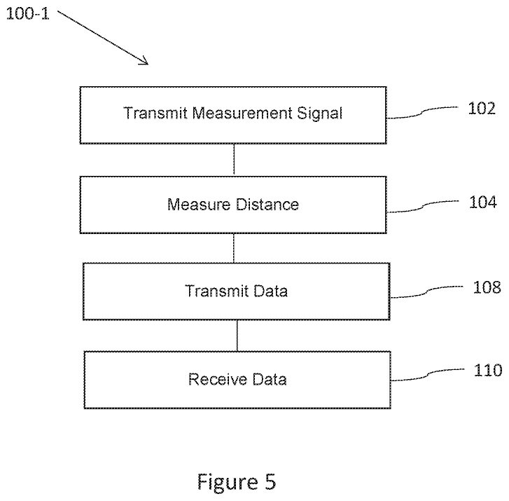

FIG. 5 illustrates a flow diagram of blocks of a method 100-1, in which relative displacement between two structures is monitored.

At block 102, a measurement signal is transmitted using a photo-emitter 12 of a distance measuring device 10.

At block 104, a distance between the distance measuring device 10 and a component of a first structure 80 is measured using a photo-sensor 13 of the distance measuring device 10. In particular a time-of-flight of the measurement signal is measured, the time-of-flight being indicative of a distance between the distance measuring device 10 and the component of the first structure 80. The distance measuring device 10 is attached to a second structure 90 separate to the first structure 80, the second structure 90 being displaceable relative to the first structure 80.

At block 108, data is transmitted from a distance measuring device data transmitter 16 to a remote resource 24 using wireless communication 23, the data relating to the displacement of the first structure 80 relative to the second structure 90.

At block 110, the data is received at the remote resource.

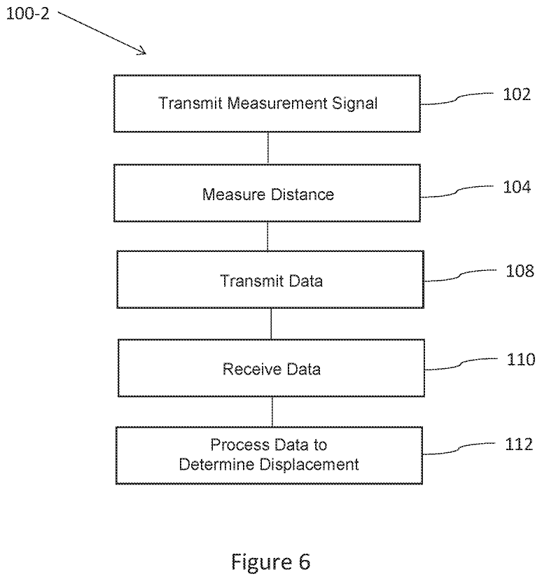

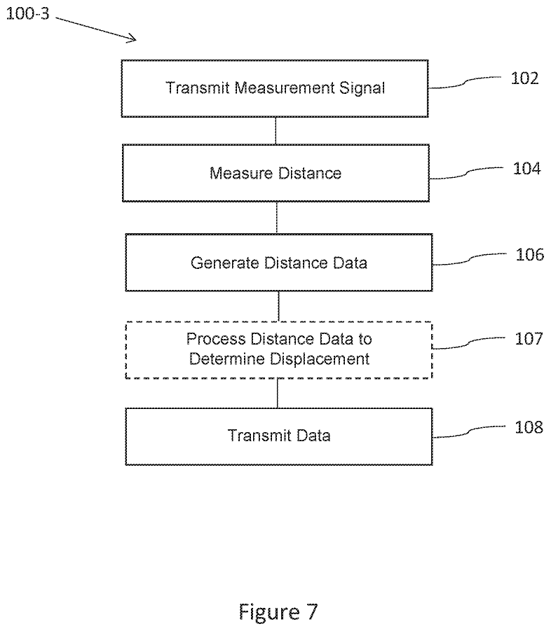

Two example methods will now be described in relation to FIG. 6 and FIG. 7, where blocks 102, 104, 108, and 110, as illustrated in FIG. 6 and FIG. 7 are the same as the corresponding blocks shown in FIG. 5 and as described above in relation to FIG. 5.

In a first example method 100-2, illustrated in FIG. 6, at block 112 the data may be processed at the remote resource 24 to determine the displacement of the first structure 80 relative to the second structure 90.

In a second example method 100-3, illustrated in FIG. 7, the data relating to the displacement of the first structure 80 relative to the second structure 90 may be distance data generated with a distance measuring device processor 14. In particular, at optional block 106, distance data indicative of the distance between the distance measuring device 10 and the component of the first structure 80 is generated with the distance measuring device processor 14. Then, rather than transmitting data relating to the displacement of the first structure 80 relative to the second structure 90 to the remote resource 24, distance data generated with the distance measuring device processor 14 is transmitted to the remote resource 24 for further processing. Further optionally, at optional block 107 the distance data generated with the distance measuring device processor 14 at block 106 is processed at the distance measuring device processor 14 to determine the displacement of the first structure 80 relative to the second structure 90. In this second example method, the data comprising the displacement of the first structure 80 relative to the second structure 90 is transmitted to the remote resource 24 at block 108.

Which of these example methods is optimal will depend on processing capacity of the distance measuring device 10 and available bandwidth to transmit data to the remote resource 24.

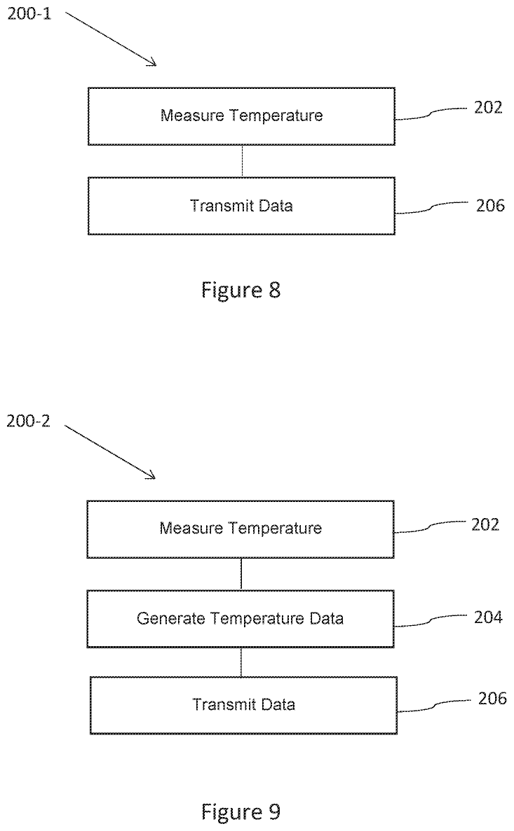

FIG. 8 illustrates a flow diagram of blocks of a method 200-1, which blocks can be used in addition to the blocks described above in relation to FIG. 5, FIG. 6, or FIG. 7, for the monitoring to the relative displacement between two structures. The method 200-1 may be carried out on a separate apparatus to that described above in relation to FIG. 5, FIG. 6, or FIG. 7, and can therefore run separate to the blocks of the method described above in relation to FIG. 5, FIG. 6, or FIG. 7.

At block 202, a temperature at or of one or both of the first structure 80 and the second structure 90 is measured with one or more temperature sensor 18.

At block 206, data relating to the temperature at or of the one or both of the first structure 80 and the second structure 90 is transmitted from a temperature measurement device data transmitter 22 to the remote resource 24 using wireless communication 23.

FIG. 9 illustrates a flow diagram of blocks of a method 200-2, which blocks can be used in addition to the blocks described above in relation to FIG. 5, FIG. 6, or FIG. 7, for the monitoring to the relative displacement between two structures. The method 200-2 may be carried out on a separate apparatus to that described above in relation to FIG. 5, FIG. 6, or FIG. 7, and can therefore run separate to the blocks of the method described above in relation to FIG. 5, FIG. 6, or FIG. 7. Blocks 202 and 206 of the method 200-2 shown in FIG. 9 are the same as blocks 202 and 206 of the method 200-1 shown in FIG. 8.

At block 202, a temperature at or of one or both of the first structure 80 and the second structure 90 is measured with one or more temperature sensor 18.

At block 204, temperature data indicative of the temperature at or of the one or both of the first structure 80 and the second structure 90 is generated with a temperature measurement device processor 20.

At block 206, data relating to the temperature at or of the one or both of the first structure 80 and the second structure 90 is transmitted from a temperature measurement device data transmitter 22 to the remote resource 24 using wireless communication 23.

Embodiments of the present techniques further provide a non-transitory data carrier carrying code which, when implemented on a processor, causes the processor to carry out the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier or on a non-transitory computer-readable medium such as a disk, microprocessor, CD- or DVD-ROM, programmed memory such as read-only memory (firmware), or on a data carrier such as an optical or electrical signal carrier. The code may be provided on a (non-transitory) carrier such as a disk, a microprocessor, CD- or DVD-ROM, programmed memory such as non-volatile memory (e.g. Flash) or read-only memory (firmware). Code (and/or data) to implement embodiments of the techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

Computer program code for carrying out operations for the above-described techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

It will also be clear to one of skill in the art that all or part of a logical method according to the preferred embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

In the preceding description, various embodiments of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

It will be clear to one skilled in the art that many improvements and modifications can be made to the foregoing example embodiments without departing from the scope of the present techniques.

In particular, in the above described embodiments, a distance measuring device 10 is defined which measures the distance between the distance measuring device 10 and the component of the first structure 80 in three axes 52, 62, 72, the distance measuring device 10 providing signals for processing at an associated distance measuring device processor 14 and having an associated distance measuring device data transmitter 16 to transmit, to a remote resource 24, data relating to the displacement of the first structure 80 relative to the second structure 90. In an alternative embodiment, three separate distance measuring devices 10 are provided each measuring on different one of the axis 52, 62, 72, each axis 52, 62, 72 being perpendicular to the other two axes. Each of the distance measuring devices 10 comprises a photo-emitter 12 and a photo-sensor 13 to measure a time-of-flight of a measurement signal transmitted from the photo-emitter 12 to the photo-sensor 13.

Therefore, each of the three a distance measuring devices 10 has a photo-emitter 12 and a photo-sensor 13 pair configured to sense or measure along one of the three axes 52, 62, 72 which can be used to measure between the respective distance measuring device 10 and the component of the first structure 80.

In such an alternative embodiment, each of the three distance measuring devices 10 may have an associated distance measuring device processor 14 and associated distance measuring device data transmitter 16. Each of the three distance measuring devices 10 can be configured to separately communicate with the remote resource 24.

In the above described embodiments, a temperature measurement device 11 is defined which may comprise a first temperature sensor 18 to measure a temperature at or of one of the first structure 80 and the second structure 90 and a second temperature sensor 18 to measure a temperature at or of the other one of the first structure 80 and the second structure 90. It is also described that more than one temperature sensor 18 may be used to determine the temperature at or of one or both of the first structure 80 and the second structure 90. In an alternative embodiment, a plurality of temperature measurement devices 11 are provided.

Each of the plurality of temperature measurement devices 11 may measure a temperature at a different position on the same or different structures 80, 90, using a temperature sensor 18. In such an alternative embodiment, each of the plurality of temperature measurement devices 11 may have an associated temperature measurement device processor 20 and associated temperature measurement device data transmitter 22. Each of the plurality of temperature measurement devices 11 can be configured to separately communicate with the remote resource 24.

In an alternative embodiment to that described above, the distance measuring device 10 measures the distance between the distance measuring device 10 and a component of a first structure 80 and provides a signal which relates to the distance measured. The signal may be provided to a separate device, such as a data logger, connected to the distance measuring device 10 either physically or by wireless communication 23. The separate device may comprise a processor and/or a transmitter. The generation of the distance data and/or the transmission, to the remote resource 24, of the data relating to the displacement of the first structure 80 relative to the second structure 90, may be carried out by the separate device.

Although the above described embodiments describe the measurement of displacement and/or temperature, it will be appreciated that other types of physical values or parameters may be measured or determined, such as humidity, vibration, sound and acceleration. These physical values or parameters may be measured by one or more respective humidity, vibration, sound and acceleration sensors. The one or more additional sensors may be separate to the distance measurement device 10 or may form part of the distance measurement device 10 and/or be collocated to share common circuitry, such as one or more of memory, processor and communication circuitry. The one or more additional sensors may transmit, to a remote resource using wireless communication, data relating to the respective measured physical values or parameters. In one example, the measurement of vibration and/or acceleration may be performed by one or more additional sensor to assist in determining and/or correcting for short term fluctuations in the displacement between the first structure 80 and the second structure 90.

The period between transmissions of the data relating to the displacement of the first structure 80 relative to the second structure 90, the data relating to the temperature at or of the one or both of the first structure 80 and the second structure 90, and/or the data relating to the one or more additionally measured physical values or parameters, may be the same or may be different to account for faster varying data values or parameters.

Some features of the disclosed embodiments are set out in the following paragraphs. These features may be combined.

In one embodiment, a method of monitoring relative displacement between two structures using a distance measuring device includes transmitting, using at least one photo-emitter of the distance measuring device, a measurement signal; measuring, using a photo-sensor of the distance measuring device, a time-of-flight of the measurement signal, the time-of-flight being indicative of a distance between the distance measuring device and a component of a first structure, the distance measuring device being attached to a second structure, and the second structure being displaceable relative to the first structure; and transmitting, from a distance measuring device data transmitter to a remote resource using wireless communication, data relating to the displacement of the first structure relative to the second structure.

In another embodiment, the method further includes generating, with a distance measuring device processor, from the measured time-of-flight, distance data indicative of the distance between the distance measuring device and the component of the first structure.

In another embodiment, the data relating to the displacement of the first structure relative to the second structure is the distance data generated with the distance measuring device processor.

In another embodiment, the distance data generated with the distance measuring device processor is processed at the remote resource to determine the displacement of the first structure relative to the second structure.

In another embodiment, the distance data generated with the distance measuring device processor is processed at the distance measuring device processor to determine the displacement of the first structure relative to the second structure.

In another embodiment, the data relating to the displacement of the first structure relative to the second structure transmitted from the distance measuring device data transmitter to the remote resource comprises the displacement of the first structure relative to the second structure.

In another embodiment, the distance measuring device is configured to measure the distance between the distance measuring device and the component of the first structure in three axes, each of the three axis being perpendicular to the other two axes.

In another embodiment, the distance measuring device further includes three photo-emitter and photo-sensor pairs, each photo-emitter and photo-sensor pair configured to measure along one of the three axes.

In another embodiment, the first structure is a first bridge section.

In another embodiment, the first bridge section comprises a surface of the first bridge section.

In another embodiment, the first structure is a box section of, or attached to, a first bridge section.

In another embodiment, the second structure is a second bridge section.

In another embodiment, the second bridge section comprises a surface of the second bridge section.

In another embodiment, the second structure is a support separate from, or attached to, a second bridge section and configured to support the distance measuring device.

In another embodiment, the method further includes measuring, with one or more temperature sensor, a temperature at or of one or both of the first structure and the second structure; and transmitting, from a temperature measurement device data transmitter to the remote resource using wireless communication, data relating to the temperature at or of the one or both of the first structure and the second structure.

In another embodiment, the method further includes generating, with a temperature measurement device processor, temperature data indicative of the temperature at or of the one or both of the first structure and the second structure.

In a further embodiment, a distance measuring device, for monitoring relative displacement between two structures, includes a photo-emitter to transmit a measurement signal; a photo-sensor to measure a time-of-flight of the measurement signal, the time-of-flight being indicative of a distance between the distance measuring device and a component of a first structure, the distance measuring device being attached, in use, to a second structure, the second structure being displaceable relative to the first structure; and a distance measuring device data transmitter to transmit, to a remote resource using wireless communication, data relating to the displacement of the first structure relative to the second structure.

In another embodiment, the distance measuring device further includes a distance measuring device processor to generate, from the measured time-of-flight, distance data indicative of the distance between the distance measuring device and the component of the first structure.

In another embodiment, the distance measuring device is configured to measure the distance between the distance measuring device and the component of the first structure in three axes, each of the three axis being perpendicular to the other two axes.

In another embodiment, the distance measuring device further includes three photo-emitter and photo-sensor pairs, each photo-emitter and photo-sensor pair configured to measure along one of the three axes.

In a further embodiment, a system for monitoring relative displacement between two structures includes a distance measuring device as described above, and a remote resource to receive data, from the distance measuring device data transmitter, relating to the displacement of a first structure relative to a second structure.

In another embodiment, the system further includes a temperature measurement device including one or more temperature sensors to measure a temperature at or of one or both of the first structure and the second structure; and a temperature measurement device data transmitter to transmit, to the remote resource, data relating to the temperature at or of one or both of the first structure and the second structure; the remote resource being configured to receive data, from the one or more temperature measurement device data transmitter, relating to the temperature at or of the one or both of the first structure and the second structure.

In another embodiment, the temperature measurement device further includes a temperature measurement device processor to generate temperature data indicative of the temperature at or of one or both of the first structure and the second structure.

In another embodiment, the system further includes a monitoring service at the remote resource to monitor the data received from the distance measuring device data transmitter.

In another embodiment, the monitoring service at the remote resource monitors the data received from the one or more temperature sensor data transmitter.

In another embodiment, the system further includes a notification service at the remote resource to notify a user when a measured parameter exceeds a predetermined threshold.

In another embodiment, the system further includes a barrier between the component of the first structure and the second structure, the distance measuring device being positioned within the barrier between the component of the first structure and the second structure.

What is claimed is:

1. A method of monitoring relative displacement between two structures using a distance measuring device, the method comprising:
transmitting, using at least one photo-emitter of the distance measuring device, a measurement signal;
measuring, using a photo-sensor of the distance measuring device, a time-of-flight of the measurement signal, the time-of-flight being indicative of a distance between the distance measuring device and a component of a first structure, the distance measuring device being attached to a second structure, the second structure being displaceable relative to the first structure; and
transmitting, from a distance measuring device data transmitter to a remote resource using wireless communication, data relating to a displacement of the first structure relative to the second structure.

2. The method of monitoring relative displacement between two structures according to claim 1, further comprising:
generating, with a distance measuring device processor, from the measured time-of-flight, distance data indicative of the distance between the distance measuring device and the component of the first structure.

3. The method of monitoring relative displacement between two structures according to claim 2, wherein the data relating to the displacement of the first structure relative to the second structure is the distance data generated with the distance measuring device processor.

4. The method of monitoring relative displacement between two structures according to claim 3, wherein the distance data generated with the distance measuring device processor is processed at the remote resource to determine the displacement of the first structure relative to the second structure.

5. The method of monitoring relative displacement between two structures according to claim 2, wherein the distance data generated with the distance measuring device processor is processed at the distance measuring device processor to determine the displacement of the first structure relative to the second structure.

6. The method of monitoring relative displacement between two structures according to claim 5, wherein the data relating to the displacement of the first structure relative to the second structure transmitted from the distance measuring device data transmitter to the remote resource comprises the displacement of the first structure relative to the second structure.

7. The method of monitoring relative displacement between two structures according to claim 1, wherein the distance measuring device is configured to measure the distance between the distance measuring device and the component of the first structure in three axes, each of the three axis being perpendicular to the other two axes.

8. The method of monitoring relative displacement between two structures according to claim 7, wherein the distance measuring device comprises three photo-emitter and photo-sensor pairs, each photo-emitter and photo-sensor pair being configured to measure along one of the three axes.

9. The method of monitoring relative displacement between two structures according to claim 1, wherein the first structure is a first bridge section, or the first structure is a box section of, or attached to, a first bridge section.

10. The method of monitoring relative displacement between two structures according to claim 9, wherein the first bridge section comprises a surface of the first bridge section.

11. The method of monitoring relative displacement between two structures according to claim 1, wherein the second structure is a second bridge section.

12. The method of monitoring relative displacement between two structures according to claim 11, wherein the second bridge section comprises a surface of the second bridge section.

13. The method of monitoring relative displacement between two structures according to claim 1, wherein the second structure is a support separate from, or attached to, a second bridge section and configured to support the distance measuring device.

14. The method of monitoring relative displacement between two structures according to claim 1, further comprising:
measuring, with one or more temperature sensor, a temperature at or of one or both of the first structure and the second structure; and
transmitting, from a temperature measurement device data transmitter to the remote resource using wireless communication, data relating to the temperature at or of the one or both of the first structure and the second structure.

15. The method of monitoring relative displacement between two structures according to claim 1, further comprising:
generating, with a temperature measurement device processor, temperature data indicative of a temperature at or of the one or both of the first structure and the second structure.

16. A distance measuring device for monitoring relative displacement between two structures, comprising:
a photo-emitter to transmit a measurement signal;
a photo-sensor to measure a time-of-flight of the measurement signal, the time-of-flight being indicative of a distance between the distance measuring device and a component of a first structure, the distance measuring device being attached, in use, to a second structure, the second structure being displaceable relative to the first structure; and
a distance measuring device data transmitter to transmit, to a remote resource using wireless communication, data relating to a displacement of the first structure relative to the second structure.

17. The distance measuring device according to claim 16, further comprising:
a distance measuring device processor to generate, from the measured time-of-flight, distance data indicative of the distance between the distance measuring device and the component of the first structure.

18. The distance measuring device according to claim 16, wherein the distance measuring device is configured to measure the distance between the distance measuring device and the component of the first structure in three axes, each of the three axis being perpendicular to the other two axes.

19. The distance measuring device according to claim 18, further comprising three photo-emitter and photo-sensor pairs, each photo-emitter and photo-sensor pair being configured to measure along one of the three axes.

20. A system for monitoring relative displacement between two structures, comprising:
a distance measuring device according to claim 16; and
a remote resource to receive data, from the distance measuring device data transmitter, relating to the displacement of a first structure relative to a second structure.
